(19) United States
(12) Patent Application Publication
(10) Pub. No.: US 2023/0306237 A1
(43) Pub. Date: Sep. 28, 2023

(54) IDENTIFY AND AVOID OVERFLOW DURING MACHINE LEARNING (ML) INFERENCE WITH HOMOMORPHIC ENCRYPTION

(71) Applicant: International Business Machines Corporation, Armonk, NY (US)

(72) Inventors: LEV GREENBERG, Haifa (IL); Ehud Aharoni, Kfar Saba (IL); GILAD EZOV, Nesher (IL)

(21) Appl. No.: 17/656,290

(22) Filed: Mar. 24, 2022

(51) Int. Cl. G06N 3/04; G06N 5/04; H04L 9/00

(52) U.S. Cl. CPC G06N 3/0454; G06N 5/043; H04L 9/008

(57) ABSTRACT

Identifying and avoiding an overflow event while performing machine learning inference operations with homomorphic encryption. Prior to a first run of a machine learning inference operation, a first overflow event is created in order to determine the values that are achieved values. These values are compared to a set of user selected homomorphic encryption libraries in order to determine which parameters of the machine learning inference operation must be adjusted in order to avoid future overflow events during subsequent runs of the machine learning inference operation.

### BACKGROUND

The present invention generally relates to the field of machine learning, and more specifically to using homomorphic encryption techniques to produce machine learning inferences.

The Wikipedia Entry for “Homomorphic encryption” (as of Jan. 28, 2022) states as follows: “Homomorphic encryption is a form of encryption that permits users to perform computations on its encrypted data without first decrypting it. These resulting computations are left in an encrypted form which, when decrypted, result in an identical output to that produced had the operations been performed on the unencrypted data. Homomorphic encryption can be used for privacy-preserving outsourced storage and computation. This allows data to be encrypted and out-sourced to commercial cloud environments for processing, all while encrypted.”

The Wikipedia Entry for “Machine learning” (as of Jan. 28, 2022) states as follows: “Machine learning (ML) is the study of computer algorithms that can improve automatically through experience and by the use of data. It is seen as a part of artificial intelligence. Machine learning algorithms build a model based on sample data, known as training data, in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.”

### SUMMARY

According to an aspect of the present invention, there is a method, computer program product and/or system that performs the following operations (not necessarily in the following order): (i) receiving, from a user, a set of input data, with the set of input data including information indicative of a training dataset used to simulate overflow events; (ii) simulating a first instance of a machine learning (ML) inference operation using the set of input data, with the simulation generating information indicating a set of values that are achieved, and with the first instance of ML interference operation causing the set of values to exceed a first overflow threshold to create a first overflow event; (iii) comparing the set of values that are achieved during the first instance of the ML inference to a first homomorphic encryption (HE) library; and (iv) responsive to the comparison, adjusting a set of parameters of the set of values in order to prevent a second overflow event.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system.

### DETAILED DESCRIPTION

Some embodiments of the present invention are directed towards identifying and avoiding an overflow event while performing machine learning inference operations with homomorphic encryption. Prior to a first run of a machine learning inference operation, a first overflow event is created in order to determine the values that are achieved values. These values are compared to a set of user selected homomorphic encryption libraries in order to determine which parameters of the machine learning inference operation must be adjusted in order to avoid future overflow events during subsequent runs of the machine learning inference operation.

This Detailed Description section is divided into the following sub-sections: (i) The Hardware and Software Environment; (ii) Example Embodiment; (iii) Further Comments and/or Embodiments; and (iv) Definitions.

### I. the Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

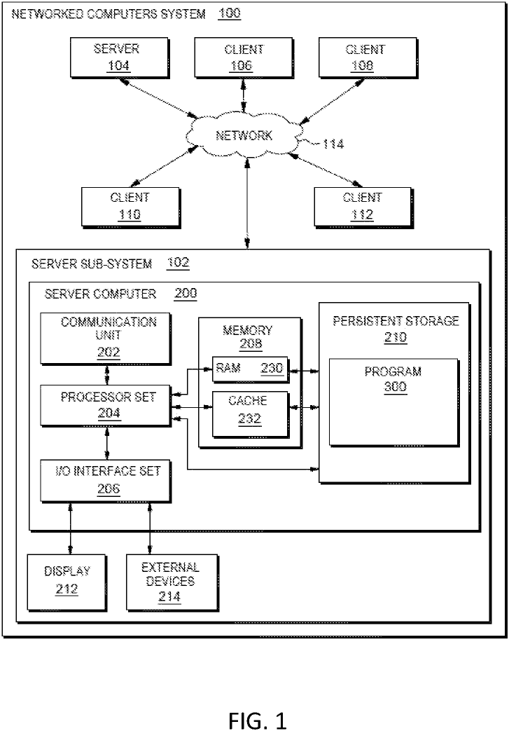

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Ii. Example Embodiment

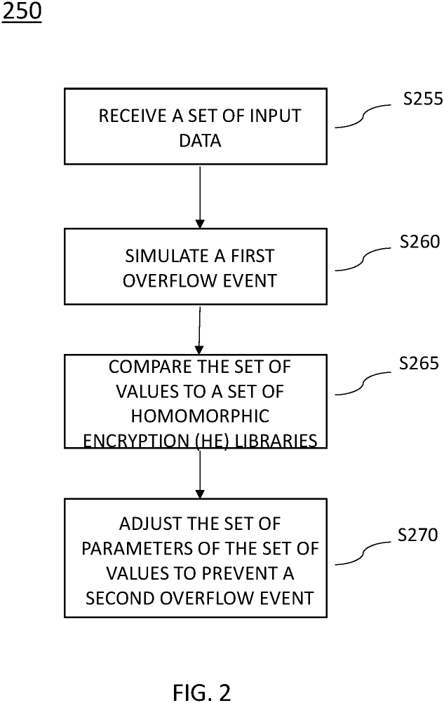

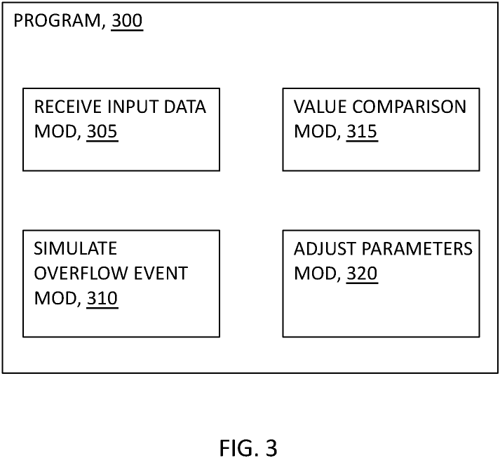

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where receive input data module (“mod”) 305 receives a set of input data from a user. In some embodiments, the set of input data includes information indicative of a training dataset used to simulate overflow events in a machine learning (ML) inference operation. This training dataset is used to train a machine learning model that performs computations on data that is encrypted without having to first decrypt that underlying data (that is, the machine learning model is used for data that is homomorphically encrypted). The set of input data that is received by the user does not necessarily have to strictly include training data, but can also be randomly generated input data, GAN generated data, or a range of data values used to calculate maximum and minimum bounds for various stages of computation for a given run of a ML inference operation. This is discussed in greater detail in Sub-Section III, below.

Processing proceeds to operation S260, where simulate overflow event mod 310 simulates a first overflow event. In some embodiments of the present invention, simulate overflow event mod 310 uses the training data received from the user (discussed in connection with operation S255, above) to simulate a potential overflow. Alternatively, simulate overflow event mod 310 can use any of the types of data that constitute the input data set (discussed in connection with operation S255, above). In some embodiments, this first run of the simulation provides the user with useful information, including a set of values that are achieved. Once this set of values is known, it can be used to ultimately determine whether the set of values have exceeded an overflow threshold (that is, the simulation produces data that indicates which values of the set of values causes the overflow during at least a first run of the ML inference operation).

Processing proceeds to operation S265, where value comparison mod 315 compares the set of values produced by the first run of the simulation of the overflow event (discussed in connection with operation S260, above) to known values that are produced using a selected set of homomorphic encryption (HE) libraries. In some embodiments, the user can select which HE library (or libraries) to utilize for this comparison. This decision rests largely on the nature of the computation being performed and the type of data that is being used (that is, the most relevant and properly curated HE libraries are selected for this comparison).

Processing finally proceeds to operation S270, where adjust parameters mod 320 adjusts a set of parameters for the set of values that are produced by the first run of the simulation and that are compared to the HE libraries (discussed respectively in connection with operations S260 and S265, above). In some embodiments, the set of parameters for the set of values are adjusted in a manner that prevents future overflow events from occurring. That is, the set of parameters are adjusted in order to ensure that when a first run of a machine learning inference operation is performed (rather than a first run of a simulation of a machine learning inference operation), an overflow event does not occur.

### Iii. Further Comments And/or Embodiments

It is important to note that some schemes and/or implementations of Homomorphic Encryption (HE) have constraints. These constraints include a limited range of permitted values (referred to as “L1”) and optionally a limitation to use activation layers that consist of only polynomial functions (referred to as “L2”). In practice, L1 and L2 might result in an overflow during a machine learning (ML) inference, which typically has a corrupting effect on the inference result.

The currently used approach for ML inference under HE is to use large prime numbers and allocate enough bits for numbers representations. The main drawbacks of the currently used approach include: (i) this approach is is not flexible and tries to find a single set of prime numbers / bits allocation, while the range of values might have high variability; and (ii) this approach is arguably wasteful in the sense that it uses memory space to overcome the overflow while inefficiently using bits that are not required for precision.

Embodiments of the present invention provide a method to avoid overflow during ML inference through the use of HE techniques. This method utilizes at least the following two concepts: (1) estimates the expected values during the ML inference; and (2) modifies the ML inference’s parameters in such a way that the expected values cannot cross an overflow threshold while preserving the inference results. In some embodiments of the present invention, the overflow threshold can vary based on the HE library that is selected and the parameters of the selected HE library (which is determined during the initial setup phase). These parameters include supported multiplication depth, precision, etc. Advantages to this approach include the ability to: (i) detect all of the computations that have an a potential overflow risk, and (ii) modify the inference in the related computation without increasing the overall memory consumption of the server system on which these computations are being performed.

The machine learning (ML) inference computation process starts with input values, and by computing all intermediate operators, computes a final set of output values.

During the inference computations, given the limitations (L1) and (L2) (referenced and defined above), some computed values might become very large and cause an overflow.

To avoid this overflow, embodiments of the present invention first estimate the ranges of values for each step of Neural Network (NN) inference computations using one of the following methods: (i) use a representative input data set (training dataset or GAN (Generative Adversarial Networks) generated data) as the inference and store the values for each computational step of the inference for this data set; (ii) use some randomly generated inputs data set as the inference and store the values for each computational step of the inference for this data set; (iii) compute worst case bounds for each computation step of the inference (e.g., given a valid/learned input range, set all inputs equals to the maximum value and replacing weights with absolute values);; and (iv) given the values ranges, estimate the upper bound on the maximum values for each computational step (for example, by using taking some fixed or statistically derived factor above the observed max value).

Next, before the modification step can be explained, certain terms and concepts need to be defined, which is done below:

### (1) ML Inference Operators’ Properties:

Examples of ML operators include two-dimensional (2D) convolution, average pooling, full-connected (FC), and poly activations. These operators are sometimes also called layers, but this document will refer to these as “operators.” In general, ML operator transforms input tensors to output tensors using certain parameters. In some instances, for example, as bias and kernel for 2D convolution operator can take on the following form:

z = F(x,p), where F is an ML operator, x is the input tensor, p is the operator’s parameters and z is the output tensor.

(2) A positive scaling preserving ML operator can be defined by the following equation: F(s*x,p)=s*F(x,p) for s>0. In this instance, all pooling operators (such as the maximum and median) are used as scaling preserving operators.

### (3) Single Operator Scaling:

For most of well-known ML operators, there is a transformation T of the operator’s parameter (p) and scaling factors s1 and s2, such that for p*= T(p,s1,s2) => F(x, p*) = s2*F(x*s1,p).

In this instance, the input (x) is scaled by factor (s1). The resulting operator F(x, p*) produces an output that is scaled by a second factor (s2).

For example, for FC layer and p =(kernel,bias) can be expressed as follows: p* = T(p,s1,s2) = (s2/s1*kernel,s2*bias).

### (4) Operators Scaling:

These are operators that scale in a manner that preserves the final results. For example, for the first scaling factor (sc1): by matching scaling of the output of the (i-1) operator and the scaling of the input of the (i) operator, the overall computations remain the same.

For example, given a sequence of operators O1 --> O2 --> O3 -->O4, it can be easily seen that by applying arbitrary scaling factors T1=(1,s12), T2=(s21,s22), T3=(s31,s32), and T4(s41,1) such that s12=s21, s22=s31, s32=s41, this application of the arbitrary scaling factors will keep the final result unchanged.

In this instance, the final result can be shown as follows: O4(O3(O2(O1(x,p1),p2),p3),p4) = O4(O3(O2(O1(x,p1*),p2*),p3*),p4*), where pi* = Ti(pi).

Additionally, “positive scaling preserving” operators can be skipped and remain without change. For example if O3 is scaling preserving operator, it can be easily seen that also for s31=s32=1 and s12*s21 = s22*s41 = 1 the final result will remain with change.

### (5) Inference Data Flow Modification:

Here, a predefined number of overflow cases will be handled.

Overflow of poly activation operator can be categorized in the following three ways: (i) overflow of leading power of poly activation (xk); (ii) overflow of partials sum of poly activations (sum ajxj); and (iii) overflow of not poly activation operator.

For each overflow case, the overflow factor (oF) will be defined are a reduction factor that needs to be applied, and can be defined as “oF = estimatedMaxValue/overflowThreshold.”

### Iv. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

and/or: inclusive or; for example, A, B “and/or” C means that at least one of A or B or C is true and applicable.

Including / include / includes: unless otherwise explicitly noted, means “including but not necessarily limited to.”

User / subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive / provide / send / input / output / report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving, from a user, a set of input data, with the set of input data including information indicative of a training dataset used to simulate overflow events;
simulating a first instance of a machine learning (ML) inference operation using the set of input data, with the simulation generating information indicating a set of values that are achieved, and with the first instance of ML interference operation causing the set of values to exceed a first overflow threshold to create a first overflow event;
comparing the set of values that are achieved during the first instance of the ML inference to a first homomorphic encryption (HE) library; and
responsive to the comparison, adjusting a set of parameters of the set of values in order to prevent a second overflow event.

2. The CIM of claim 1 further comprising:
simulating a second instance of the ML inference operation, with the simulation generating information indicating a second set of values that are achieved; and
determining that the second set of values that are achieved fall below the first overflow threshold.

3. The CIM of claim 1 wherein the set of parameters of the set of values relate to a first machine learning (ML) model, and with the first ML model being structured and configured to run a plurality of ML inference operations.

4. The CIM of claim 1 wherein the training dataset used to simulate overflow events is a GAN generated dataset.

5. The CIM of claim 1 wherein the training dataset used to simulate overflow events is a randomly generated input dataset.

6. The CIM of claim 1 wherein the training dataset used to simulate overflow events is a range of data used to compute a worst case bounds for each computation step of the ML inference operation.

7. A computer program product (CPP) comprising:
a machine readable storage device; and
computer code stored on the machine readable storage device, with the computer code including instructions and data for causing a processor(s) set to perform operations including the following:
receiving, from a user, a set of input data, with the set of input data including information indicative of a training dataset used to simulate overflow events,
simulating a first instance of a machine learning (ML) inference operation using the set of input data, with the simulation generating information indicating a set of values that are achieved, and with the first instance of ML interference operation causing the set of values to exceed a first overflow threshold to create a first overflow event,
comparing the set of values that are achieved during the first instance of the ML inference to a first homomorphic encryption (HE) library, and
responsive to the comparison, adjusting a set of parameters of the set of values in order to prevent a second overflow event.

8. The CPP of claim 7 further comprising:
simulating a second instance of the ML inference operation, with the simulation generating information indicating a second set of values that are achieved; and
determining that the second set of values that are achieved fall below the first overflow threshold.

9. The CPP of claim 7 wherein the set of parameters of the set of values relate to a first machine learning (ML) model, and with the first ML model being structured and configured to run a plurality of ML inference operations.

10. The CPP of claim 7 wherein the training dataset used to simulate overflow events is a GAN generated dataset.

11. The CPP of claim 7 wherein the training dataset used to simulate overflow events is a randomly generated input dataset.

12. The CPP of claim 7 wherein the training dataset used to simulate overflow events is a range of data used to compute a worst case bounds for each computation step of the ML inference operation.

13. A computer system (CS) comprising:
a processor(s) set;
a machine readable storage device; and
computer code stored on the machine readable storage device, with the computer code including instructions and data for causing the processor(s) set to perform operations including the following:
receiving, from a user, a set of input data, with the set of input data including information indicative of a training dataset used to simulate overflow events,
simulating a first instance of a machine learning (ML) inference operation using the set of input data, with the simulation generating information indicating a set of values that are achieved, and with the first instance of ML interference operation causing the set of values to exceed a first overflow threshold to create a first overflow event,
comparing the set of values that are achieved during the first instance of the ML inference to a first homomorphic encryption (HE) library, and
responsive to the comparison, adjusting a set of parameters of the set of values in order to prevent a second overflow event.

14. The CS of claim 13 further comprising:
simulating a second instance of the ML inference operation, with the simulation generating information indicating a second set of values that are achieved; and
determining that the second set of values that are achieved fall below the first overflow threshold.

15. The CS of claim 13 wherein the set of parameters of the set of values relate to a first machine learning (ML) model, and with the first ML model being structured and configured to run a plurality of ML inference operations.

16. The CS of claim 13 wherein the training dataset used to simulate overflow events is a GAN generated dataset.

17. The CS of claim 13 wherein the training dataset used to simulate overflow events is a randomly generated input dataset.

18. The CS of claim 13 wherein the training dataset used to simulate overflow events is a range of data used to compute a worst case bounds for each computation step of the ML inference operation.
